(19) United States
(12) Patent Application Publication
(10) Pub. No.: US 2009/0176939 A1
(43) Pub. Date: Jul. 9, 2009

(54) SEEDED GROW-OUT RUBBER POLYMERIZATION PROCESS

(75) Inventor: Jason S. Ness, East Norriton, PA (US)

Correspondence Address: ARKEMA INC.;PATENT DEPARTMENT - 26TH FLOOR, 2000 MARKET STREET, PHILADELPHIA, PA, 19103-3222, US

(73) Assignee: Arkema Inc., Philadelphia, PA (US)

(21) Appl. No.: 11/971,282

(22) Filed: Jan. 9, 2008

(51) Int. Cl. C08L 9/00

(52) U.S. Cl. 525/232

(57) ABSTRACT

The invention relates to a high productivity process for the production of rubber latex particles. This improved productivity process involves using a seeded grow-out process to prepare polybutadiene rubber latex. The use of a pre-formed seed latex reduces cycle time relative to an in situ polybutadiene seed process. It also provides better particle size control. The rubber latex particles can be used for impact modification of thermoplastic compositions.

### FIELD OF THE INVENTION

This invention relates to a high productivity process for the production of rubber latex particles. This improved productivity process involves using a seeded grow-out process to prepare polybutadiene rubber latex. The use of a pre-formed polybutadiene seed latex reduces cycle time relative to an in situ seed process. It also provides better particle size control. The rubber latex particles can be used for impact modification of thermoplastic compositions.

### BACKGROUND OF THE INVENTION

Polycarbonate and polyester resins have found many commercial uses. Blends of polycarbonate and polyester-based polymers capitalize on the strengths of each polymer and have been found to exhibit excellent physical properties such as rigidity, hardness, scuff resistance, and stability under dynamic and thermal stress. They are also easy to process. A deficiency with these resins is their mechanical properties, especially impact resistance.

Attempts have been made to improve the physical properties through the addition of core-shell impact modifiers. U.S. Pat. No. 4,535,124 discloses the use of a core-shell impact modifier having a bimodal diene or alkyl acrylate rubber core. U.S. Pat. No. 5,367,021 discloses a graft copolymer diene rubber core with an optional shell, having particle sizes between 200 and 300 nm. U.S. Pat. No. 5,969,041 discloses a composition having two different core-shell polymer particles, each with a styrene acrylonitrile shell.

A core-shell emulsion polymer having a butadiene-based core and a particle size of from 100 to 200 nm is disclosed in U.S. Pat. No. 6,407,167. All examples of core polymers contained 15-20 percent styrene.

WO 06/05777 (U.S. Ser. No. 11/719,814), incorporated herein by reference, describes an impact modifier with little or no styrene in the core of the core-shell impact modifier, which produces improved impact resistance and dispersibility in a polycarbonate/polyester-based resin composition. The modifier composition is synthesized by forming a polybutadiene seed in situ, followed by a grow-out process. This process takes a large amount of process time.

It has now been found that forming a butadiene-based core-shell latex using a pre-formed polybutadiene seed latex in a grow-out process not only substantially reduces the cycle time relative to an in situ polybutadiene seed process, but also further affords better final rubber latex particle size control and greater reproducibility of rubber latex particle size relative to the in situ seed process.

### SUMMARY OF THE INVENTION

An objective of the invention is to reduce the cycle time and improve the properties of polybutadiene-based modifiers formed in a grow-out process.

The object of the invention is met by using a process for forming a core-shell graft copolymer comprising the steps of
a) charging a pre-formed polybutadiene seed latex to a reactor;
b) heating the seed latex with agitation;
c) adding a 1,3-butadiene monomer feed, initiator, surfactant and water continuously over time to form a butadiene rubber latex having a weight average particle diameter of from 120-250 nm;
d) graft polymerizing one or more polymer shells onto said butadiene particles to form core-shell particles having
   1) 70 to 90 percent by weight of a core polymer comprising from 90 to 100 percent by weight of butadiene monomer units; and
   2) 10 to 30 percent by weight of one or more shell polymer layers comprising one or more ethylenically unsaturated monomer units.

### DETAILED DESCRIPTION OF THE INVENTION

The process of the invention relates to forming a core-shell graft copolymer using a pre-formed polybutadiene seed latex in a grow-out process, rather than forming the polybutadiene seed in situ. In addition to substantially reducing the cycle time, the improved process produces more reproducible latex particles with improved properties over similar latex particles formed by an in situ seed process. The reduction in cycle time of the formation of the polybutadiene rubber particle can be reduced by 10 percent, 20 percent and even more, depending on the process conditions—such as temperature and initiator.

The polybutadiene seed latex is formed by the emulsion polymerization of from 90 to 100 percent by weight of 1,3-butadiene monomer and 0 to 10 percent by weight of one or more vinyl-based monomers copolymerizable with 1,3-butadiene. Examples of the vinyl-based monomer include, but are not limited to aromatic vinyls such as styrene, alpha-methylstyrene, and various halogen-substituted and alkyl-substituted styrene. In a preferred embodiment no vinyl-based monomers are copolymerized in the seed. If styrene is used in the seed, the level of styrene will be less than 5 percent. In a preferred embodiment, no styrene monomer is used in polymerizing the seed. It was found that deceasing or elimination of styrene from the seed and core improved the impact modification provided by the core-shell impact modifier when used in a thermoplastic resin.

Cross-linking monomers may also be included in the seed polymer. Cross-linking monomers useful in the present invention include, but are not limited to aromatic polyfunctional vinyl compounds such as divinylbenzene and divinyltoluene, polyhydric alcohols such as ethylene glycol dimethacrylate and 1,3-butanediol diacrylate, trimethacrylates, triacrylates, allyl carboxylates such as allyl acrylate and allyl methacrylate, and di and tri-allyl compounds such as diallyl phthalate, diallyl sebacate, and triallyltriazine. In a preferred embodiment, no cross-linking monomer units are in the core polymer.

Chain transfer agents are also useful in forming the seed polymer. Useful chain transfer agents include those known in the art, including but not limited to t-dodecylmercaptan, n-octylmercaptan, and mixtures of chain transfer agents. The chain transfer agent is used at levels from 0 to 2 percent by weight, based on the total seed monomer content. In a preferred embodiment, 0.2 to 1 percent chain transfer agent is used in forming the seed polymer.

The polybutadiene seed latex may be formed using emulsion polymerization methods known to those skilled in the art, including a batch or grow-out process. In a preferred embodiment, a batch process is used to form the polybutadiene seed. The seed latex will have a weight average particle size of from 40 to 120 nm and preferably from 50 to 90 nm.

The butadiene-based rubber core of the core-shell polymer is synthesized by a grow-out process whereby the pre-formed seed polymer is grown by the polymerization of additional 1,3-butadiene monomer feed. This grow-out polymerization results in an increase in polybutadiene rubber latex particle size dictated by the seed-to-grow-out mass ratio. The seed polymer is charged to a reactor, along with water, and preferably on organic initiator, such as a peroxide. The mixture is then heated to from 40° C. to 80° C. depending on the polymerization initiator used. Optionally some emulsifier may also be added to the initial charge.

The monomer(s), reductant, emulsifier, and initiator are then added in a continuous manner over a period of time. By continuous is meant either a constant stream, or small shots of feeds added periodically. The monomers and other adjuncts may be added as separate feeds, or mixed together and the mixture added over time. The 1,3-butadiene monomer feed consists of from 90 to 100 percent by weight of 1,3-butadiene monomer and 0 to 10 percent by weight of one or more vinyl-based monomers copolymerizable with 1,3-butadiene. The monomer feed may be the same or different from that used in the seed polymer. In one embodiment, a portion of the emulsifier, reductant, and initiator continue to be added after all of the monomer feed has been added to the reactor.

In one embodiment a reactor is charged with: water, a prescribed amount of polybutadiene seed latex (e.g., 4% by mass relative to final polybutadiene polymer), and initiator. This mixture is degassed and heated to reaction temperature. A catalyst solution is next added to the reactor followed by the commencement of semi-batch feed streams of butadiene (fed over 8 hours), a solution of surfactant and water (fed over 13 hours), and initiator (fed over 18 hours, or batch charged hourly over 18 hours). The reaction is maintained at a prescribed reaction temperature until the butadiene is >95% converted.

The butadiene-based rubber polymer of the invention has a weight-average particle size of from 120 to 200 nm, and preferably from 140 to 190 nm. The ratio of the weight-average particle size to the number-average particle size is from 1 to 3, preferably 1 to 2.

The butadiene-based rubber particles can be used to form core-shell impact modifiers by graft-polymerizing a monomer or monomer mixture containing at least an aromatic vinyl, alkyl methacrylate, alkyl acrylate, or unsaturated nitrile in the presence of a latex containing the butadiene-based rubber polymer. The core polymer of the present invention makes up from 70 to 90 percent by weight of the core-shell graft polymer. The shell polymer makes up from 10 to 30 percent by weight of the core-shell graft polymer.

Monomers useful in forming the shell polymer include aromatic vinyls such as styrene, alpha-methylstyrene and various halogen-substituted and alkyl-substituted styrene; alkyl methacrylates such as methyl methacrylate, and ethyl methacryalte; alkyl acrylates such as ethyl acrylate and n-butyl acrylate; unsaturated nitriles such as acrylonitrile and methacrylonitrile; and vinyl-based monomers having a glycidyl group such as glycidyl acrylate, glycidyl methacryalte, allyl glycidyl ether, and ethylene glycol glycidyl ether. These monomer can be used alone or in combination of two or more. In one preferred embodiment the shell contains from 90-100 percent by weight of alkyl(meth)acrylate monomer units. A shell of 100 percent methyl methacrylate, or of 95-100 percent methacrylate and 0-5 percent ethyl acrylate is especially preferred.

Cross-linking monomers at from 0 to 6 percent by weight may be used to form the shell polymer. Preferably a cross-linker is present in the shell at from 0.5 to 2.5 percent. Cross-linking monomers useful in the shell include, but are not limited to aromatic polyfunctional vinyl compounds such as divinylbenzene and divinyltoluene, polyhydric alcohols such as ethylene glycol dimethacrylate and 1,3-butanediol diacrylate, trimethacrylates, triacrylates, allyl carboxylates such as allyl acrylate and allyl methacrylate, and di and tri-allyl compounds such as diallyl phthalate, diallyl sebacate, and triallyltriazine. A shell of 100 percent methyl methacrylate, or 98-100 percent methyacrylate, 0-5 percent ethyl acrylate, and 0-2 percent divinylbenzene is especially preferred.

As the graft polymerization method, an emulsion polymerization method is used. The polymerization can occur at temperatures in the range from 40 to 80° C., depending on the polymerization initiator. As the emulsifier, known emulsifiers can appropriately be used. Preferably the grafting is done by adding the shell monomers continuously. The shell may be formed as a single shell, or in the form of a multiple shell. A single shell is preferred, as the process is simpler and less time consuming. The core-shell polymer is useful as an impact modifier for thermoplastics, including but not limited to polycarbonates, polyester-based resin, or a mixture thereof.

The preferred embodiments of our invention will be exemplified by the following examples. One skilled in the art will realize that minor variations outside the embodiments stated herein do not depart from the spirit and scope of this invention. “Parts” and “%” in examples and comparative examples indicate “parts by weight” and “% by weight”, respectively.

### EXAMPLES

### Example 1 (Comparative)

### Polymerization of Butadiene Rubber Polymer Latex (R₁)

To a 1-gallon high-pressure reactor was charged: de-ionized water, emulsifier, 1,3-butadiene, t-dodecyl mercaptan, and p-menthane hydroperoxide as an initial kettle charge, as outlined below. The solution was heated, with agitation, to 43° C. at which time a redox-based catalyst solution was charged, effectively initiating the polymerization. Then the solution was further heated to 56° C. and held at this temperature for a period of three hours.

Three hours after polymerization initiation, a second monomer charge, one-half of an additional emulsifier and reductant charge, and additional initiator were continuously added over eight hours. Following the completion of the second monomer addition, the remaining emulsifier and reductant charge plus initiator was continuously added over an additional five hours.

Thirteen hours after polymerization initiation, the solution was heated to 68° C. and allowed to react until at least twenty hours had elapsed since polymerization initiation, producing butadiene rubber latex, R₁.

Butadiene Rubber Latex, R₁
Kettle Charge

| | | |
|---|---|---|
| deionized water | 116.5 | parts |
| beef tallow fatty acid, potassium salt | 0.1 | parts |
| 1,3-butadiene | 21.9 | parts |
| t-dodecyl mercaptan | 0.1 | parts |

Initiator

| | | |
|---|---|---|
| p-menthane hydroperoxide | 0.1 | parts |

Redox-based Catalyst

| | | |
|---|---|---|
| deionized water | 4.5 | parts |
| sodium tetrapyrophosphate | 0.3 | parts |
| ferrous sulfate | 0.004 | parts |
| dextrose | 0.3 | parts |

Second Monomer

| | | |
|---|---|---|
| 1,3-butadiene | 77.8 | parts |
| t-dodecyl mercaptan | 0.2 | parts |

Emulsifier & Reductant

| | | |
|---|---|---|
| deionized water | 30.4 | parts |
| beef tallow fatty acid, potassium salt | 2.8 | parts |
| dextrose | 0.5 | parts |

Initiator

| | | |
|---|---|---|
| p-menthane hydroperoxide | 0.8 | parts |

The resultant butadiene rubber latex (R₁) contained 38% solids and had a particle size, d_{w}, of ≈160 nm and a d_{w}/dₙ of 1.1.

### Example 2 (Of the Invention)

### Polymerization of Butadiene-Based Rubber Polymer Latex (R₂)

To a 20-liter high-pressure reactor was charged: de-ionized water, poly(butadiene) seed latex, and p-menthane hydroperoxide, as outlined below. The solution was agitated at 40 rpm, sparged with nitrogen, and heated to 56° C. at which time a redox-based catalyst solution was charged and allowed to mix for 15 minutes. Then monomer charge, one-half the total emulsifier and reductant charge, and initiator were continuously added over a period of eight hours. Following the completion of monomer addition, the remaining emulsifier and reductant charge as well as initiator were continuously added over an five additional hours.

Eleven hours after the onset of the continuous monomer addition, the temperature was increased to 68° C. and held until the butadiene achieved quantitative conversion, producing poly(butadiene) latex, R₂.

The resultant butadiene rubber latex (R₂) contained 46.1% solids and a latex particle size, d_{w} of ≈180±10 nm and a d_{w}/dₙ of 1.1.

Butadiene Rubber Latex, R₂
Kettle Charge

| | | |
|---|---|---|
| deionized water | 85.2 | parts |
| poly(butadiene) latex (d_{w} ≈ 68 ± 5 nm) | 4.1 | parts |
| p-menthane hydroperoxide | 0.07 | parts |

Redox-based Catalyst

| | | |
|---|---|---|
| deionized water | 2.8 | parts |
| sodium tetrapyrophosphate | 0.3 | parts |
| ferrous sulfate | 0.004 | parts |
| dextrose | 0.05 | parts |

Monomer

| | | |
|---|---|---|
| 1,3-butadiene | 95.6 | parts |
| t-dodecyl mercaptan | 0.3 | parts |

Emulsifier & Reductant

| | | parts |
|---|---|---|
| deionized water | 34.5 | parts |
| beef tallow fatty acid, potassium salt | 2.47 | parts |
| dextrose | 0.98 | parts |

Initiator

| | | |
|---|---|---|
| p-menthane hydroperoxide | 0.85 | parts |

### Example 3 (Comparative)

### Polymerization of Butadiene-Based Rubber Polymer Latex (R₃)

Using the rubber latex polymerization procedure outline in Example 1, the following composition was utilized to produce butadiene-based rubber latex, R₃.

Butadiene-based Rubber Latex, R₃
Kettle Charge

| | | |
|---|---|---|
| deionized water | 116.5 | parts |
| beef tallow fatty acid, potassium salt | 0.1 | parts |
| 1,3-butadiene | 20.8 | parts |
| styrene | 1.1 | parts |
| t-dodecyl mercaptan | 0.1 | parts |

Initiator

| | | |
|---|---|---|
| p-menthane hydroperoxide | 0.1 | parts |

Redox-based Catalyst

| | | |
|---|---|---|
| deionized water | 4.5 | parts |
| sodium tetrapyrophosphate | 0.3 | parts |
| ferrous sulfate | 0.004 | parts |
| dextrose | 0.3 | parts |

Second Monomer

| | | |
|---|---|---|
| 1,3-butadiene | 77.7 | parts |
| styrene | 3.9 | parts |
| t-dodecyl mercaptan | 0.5 | parts |

Emulsifier & Reductant

| | | |
|---|---|---|
| deionized water | 30.4 | parts |
| beef tallow fatty acid, potassium salt | 2.8 | parts |
| dextrose | 0.5 | parts |

Initiator

| | | |
|---|---|---|
| p-menthane hydroperoxide | 0.8 | parts |

The resultant butadiene rubber latex (R₃) contained 38% solids and had a particle size, d_{w}, of ≈160 nm and a d_{w}/dₙ of 1.1 .

### Example 4

### Polymerization of Graft Copolymer (G₁)

Into a 5 Liter glass reactor is charged 75.0 parts, on a solids basis, of butadiene rubber latex of Examples 1-3, 37.6 parts de-ionized water, and 0.1 parts sodium formaldehyde sulfoxylate, as outlined in the composition below. The solution is agitated, purged with nitrogen, and heated to 77° C. When the solution reaches 77° C., a mixture of 25.0 parts monomer(s) and 0.1 parts t-butyl hydroperoxide initiator is continuously added over 70 minutes, followed by a hold period of 80 minutes. Thirty minutes after the onset of the hold period, 0.1 parts of sodium formaldehyde sulfoxylate and 0.1 parts t-butyl hydroperoxide are added to the reactor at once.

Graft Copolymer, G₁
Kettle Charge

| | | |
|---|---|---|
| butadiene rubber latex (as solids) | 75.0 | parts |
| deionized water | 37.6 | parts |
| sodium formaldehyde sulfoxylate | 0.2 | parts |

Monomer Charge

| | | |
|---|---|---|
| methyl methacrylate | 25.0 | parts |
| ethyl acrylate | 0.0 | parts |
| divinyl benzene | 0.0 | parts |

Initiator

| | | |
|---|---|---|
| t-butyl hydroperoxide | 0.2 | parts |

Following the 80-minute hold period, a stabilization emulsion is added to the graft copolymer latex. The stabilization emulsion is prepared by mixing 5.4 parts de-ionized water (based on graft copolymer mass), 0.1 parts oleic acid, 0.02 parts potassium hydroxide, 0.1 parts diluaryl thiodipropionate, and 0.24 parts triethyleneglycol-bis[3-(3-t-butyl-4-hydroxy-5-methylphenyl)-propionate].

The graft copolymer latex is added to a 0.9% aqueous sulfuric acid solution resulting in a coagulated material that was heat treated at 85° C., to further solidify. Subsequently, the coagulated material is filtered, washed with warm de-ionized water, and dried to produce a graft copolymer, G₁.

### Example 5

### Polymerization of Graft Copolymer (G₂)

Using the same graft copolymer polymerization procedure outline in Example 4, the following composition was utilized to produce graft copolymer G₂.

Graft Copolymer, G₃
Kettle Charge

| | | |
|---|---|---|
| butadiene rubber latex (as solids) | 75.0 | parts |
| deionized water | 37.6 | parts |
| sodium formaldehyde sulfoxylate | 0.2 | parts |

Monomer Charge

| | | |
|---|---|---|
| methyl methacrylate | 22.6 | parts |
| ethyl acrylate | 1.1 | parts |
| divinyl benzene | 1.4 | parts |

Initiator

| | | |
|---|---|---|
| t-butyl hydroperoxide | 0.2 | parts |

Various physical properties in the following examples and comparative examples were measured by the following methods. Measurements to determine % solids were performed using a CEM SMART SYSTEM 5® moisture/solids analyzer. Weight-average particle size, d_{w} and number-average particle size, dₙ were measured by a capillary-mode particle size distribution measuring apparatus.

1. A process for forming a butadiene-based core-shell graft copolymer comprising the steps of
a) charging a pre-formed polybutadiene seed latex to a reactor;
b) heating the seed latex with agitation;
c) adding a 1,3-butadiene monomer feed, initiator, surfactant and water continuously over time to form a butadiene rubber latex having a weight average particle diameter of from 120-250 nm;
d) graft polymerizing one or more polymer shells onto said butadiene particles to form core-shell particles having
a. 70 to 90 percent by weight of a core polymer comprising from 90 to 100 percent by weight of butadiene monomer units; and
b. 10 to 30 percent by weight of one or more shell polymer layers comprising one or more ethylenically unsaturated monomer units.

2. The process of claim 1 wherein said seed latex comprises 100 percent by weight of butadiene monomer units.

3. The process of claim 1 wherein said seed latex further comprises from 0 to 2 percent by weight of a chain transfer agent and/or 0 to 2 percent by weight of a cross-linking monomer.

4. The process of claim 1 wherein said 1,3-butadiene monomer feed comprises monomer that is 100 percent butadiene monomer.

5. The process of claim 4 wherein said 1,3-butadiene monomer feed further comprises from 0 to 2 percent by weight of a chain transfer agent and/or 0 to 2 percent by weight of a cross-linking monomer.

6. The process of claim 1 wherein said seed latex has a weight average particle size of from 40 to 120 nm.

7. The process of claim 1 wherein said shell comprises 90 to 100 percent by weight of alkyl(meth)acrylate monomer units.

8. The process of claim 7 wherein said alkyl(meth)acrylate monomer units comprise from 95 to 100 percent by weight of methylmethacrylate.

9. The process of claim 1 wherein said shell polymer consists of a single shell layer.

10. The process of claim 1 wherein said shell polymer comprises from 0 to 8 percent by weight of cross-linker monomer units.

11. (canceled)
